(19) United States
(12) Patent Application Publication
(10) Pub. No.: US 2013/0134640 A1
(43) Pub. Date: May 30, 2013

(54) CORNER AND EDGE CUSHIONING DEVICE, SYSTEM AND METHOD OF USING SAME

(71) Applicant: Gina Thaxton, Sherman Oaks, CA (US)

(72) Inventor: Gina Thaxton, Sherman Oaks, CA (US)

(21) Appl. No.: 13/663,775

(22) Filed: Oct. 30, 2012

Related U.S. Application Data
(60) Provisional application No. 61/564,730, filed on Nov. 29, 2011.

(51) Int. Cl. A47B 97/00; B23Q 17/00; F16F 7/00

(52) U.S. Cl. 267/140; 29/407.05

(57) ABSTRACT

A cushioning device, as well as to a system and a method of using such device, is provided. The device protects children from injuries when they come into unintended contact the corners and edges of tables or other furniture items. The cushioning device uses no adhesive, can be easily and removably applied to the table or other furniture item and is aesthetically pleasing to the user. The device is comprised of a nearly transparent elastomeric material and can be configured in a band-like fashion or in a linear fashion where the ends are secured, thermally, chemically or mechanically, to simulate a band-like structure. The cushioning device further comprises a system whereby the cushioning device uses the connection means to create the band-like structure mentioned above. It also comprises a method for applying the cushioning device to a table or other furniture item. When in place, the device is virtually invisible.

This application claims the benefit and priority of U.S. Provisional Patent Application No. 61/564,730 filed Nov. 29, 2011.

### FIELD OF THE INVENTION

This invention relates generally to devices, systems and methods that are used to protect people from contact injuries. More specifically, the present invention relates to a cushioning device, as well as to a system and a method of using such device, that protects children from injuries when they forcefully and accidentally contact the corners and edges of tables or other furniture items.

### BACKGROUND OF THE INVENTION

The fact that children can be unintentionally injured when falling against the edge of a table or other furniture is well known to any parent, including the present inventor. As used in this disclosure, the phrase “table or other furniture item” is intended by this inventor to include virtually any object or item having a relatively hard and/or sharp edge or corner to it, which edge or corner is hard enough or sharp enough to create a hazard to any child who impacts her or his head or other body part on such edge or corner.

To solve this problem, prior art exists whereby a cushioned edge is built directly into the corner or edge of the table or other furniture item. While this solution can and does work to reduce the severity of such injuries, the solution is typically an expensive one and results in a table or other furniture item that can be extremely unappealing in an aesthetic sense. Further, such a solution can only be made at the time of original manufacture of the table or other furniture item. In the extremely competitive market of consumer sales, building such edges into a table or other furniture items raises the material and labor costs for the manufacturer. This is a disincentive for the manufacturer who must pass these costs on to the consumer. Lastly, such a solution cannot be an after-market solution for the problem.

Another solution in the prior art is to attach a more temporary cushioning structure to the subject edge or corner of the table or other furniture item. While this solution allows for after-market application, it can also result in limited protection that is not long lasting. This is because the adhesive means that is typically used to attach the temporary cushioning structure can break down over time. It can also leave an adhesive residue on the table or other furniture item, which residue may be difficult to remove. Perhaps the biggest problem with this solution is not that it does not work, but that it does not look aesthetically appealing. That is, use of such an after-market safety solution is usually unattractive.

In the view of this inventor, what is needed is a corner or edge cushioning device that can be used with such a corner or edge in a way that is easy to apply, that makes the cushioning device easily removable, that requires no adhesive substance to adhere it and that is also visually pleasing to the eye once it is attached. As to the last point, what is needed is such a cushioning device that is effectively “invisible” because it blends into the surface with which the cushioning device is used or onto which the cushioning device is applied. What is also needed is such a cushioning device that can be fabricated from an elastomeric-type material as an extensible band-like member, very much like an over-sized “rubber band.” It is also necessary to create such a cushioning device that can be fabricated in a linear fashion and then cut such that two ends are created, which ends can be easily fastened together, by heat, chemical or mechanical bond, to create the band-like member in a more customized way. This would allow the cushioning device of the present invention to be used with virtually any size table or other furniture item in accordance with the intended purpose of the present invention.

Accordingly, it is an object of the present invention to provide a new and useful cushioning device, as well as to a system and a method of using such device, that protects children from injuries when they forcefully and accidentally contact the corners and edges of tables or other furniture items. It is another object to provide such a cushioning device that uses no adhesive but which is also capable of removable application to the table or other furniture item. It is yet another object to provide such a cushioning device that is aesthetically pleasing to the user. It is still another object to provide such a cushioning device that is configured in a band-like fashion or is configure in a linear fashion but can be secured at two ends so as to simulate the band-like structure. Lastly, it is yet another object to provide a cushioning device system that uses a connection means to create the band-like structure as well as a method for applying the device to a table or other furniture item in accordance with the present invention.

### SUMMARY OF THE INVENTION

The device of the present invention has obtained these objects. It provides for a cushioning device, as well as to a system and a method of using such device, that protects children from injuries when they come into unintended contact the corners and edges of tables or other furniture items. The cushioning device and system uses no adhesive, can be easily and removably applied to the table or other furniture item and is aesthetically pleasing to the user. The cushioning device can be configured in a band-like fashion or is configured in a linear fashion but can be secured at two ends so as to simulate the band-like structure. The cushioning device further comprises a system whereby the cushioning device uses a connection means to create the band-like structure mentioned above. That is, the ends could be secured by chemical means or by mechanical means. The present invention also comprises a method for applying the cushioning device to a table or other furniture item in accordance with the structure that is also disclosed in accordance with the present invention.

The foregoing and other features of the cushioning device, assembly and method of the present invention will be apparent from the detailed description that follows.

### BRIEF DESCRIPTION OF THE DRAWINGS

FIG. 1 is a perspective view of a preferred embodiment of a cushioning device that is constructed in accordance with the present invention prior to application of the device to the edge of a table.

FIG. 2 is a perspective view of the cushioning device illustrated in FIG. 1 and showing the device applied to the edge of a table.

FIG. 3 is an enlarged perspective view of a section of the cushioning device of the present invention.

FIG. 4 is an enlarged cross-sectioned side elevational view of the cushioning device of the present invention.

FIG. 5A is a cross-sectioned side elevational view of the cushioning device as applied to a square-edged table taken along line 5-5 of FIG. 2.

FIG. 5B is a cross-sectioned side elevational view of the cushioning device as applied to a table edge having a contour.

FIGS. 6A through 6C are top plan views showing how the ends to a section of the cushioning device could be attached.

FIG. 7 is an end view of an alternative configuration for the cushioning device of the present invention.

FIG. 8 is a perspective view of the cushioning device shown in FIG. 7 prior to mounting the device to an L-shaped door handle.

FIG. 9 is a perspective view of the cushioning device shown in FIG. 8 after it is mounted to an L-shaped door handle.

FIG. 10 is a perspective view of a second alternative configuration for the cushioning device of the present invention shown mounted to a conventional round door knob.

### DETAILED DESCRIPTION

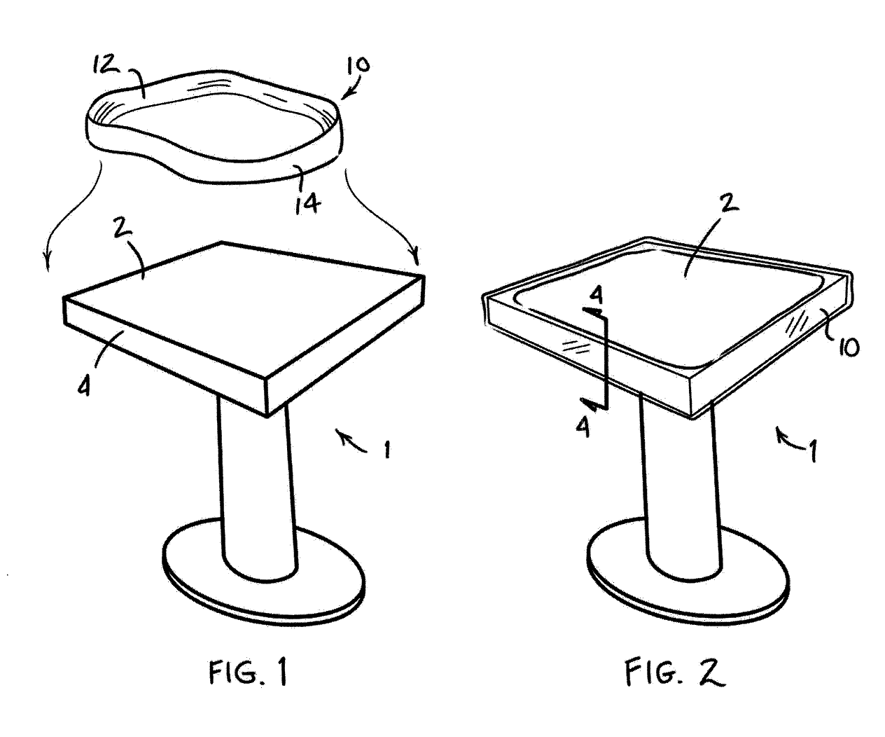

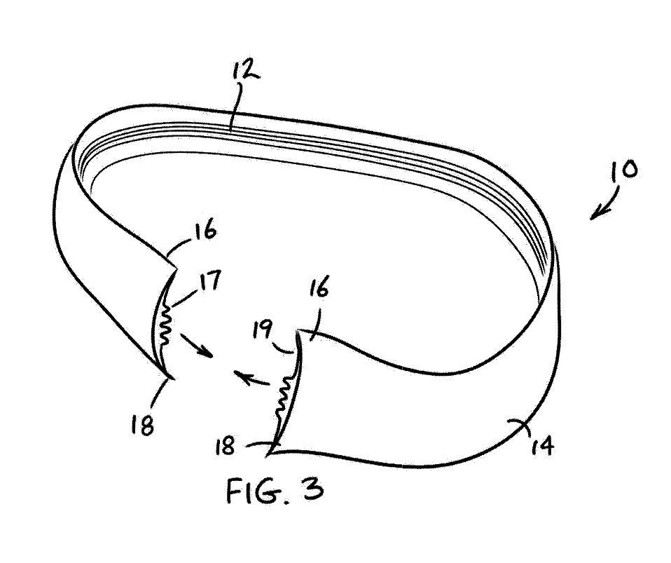

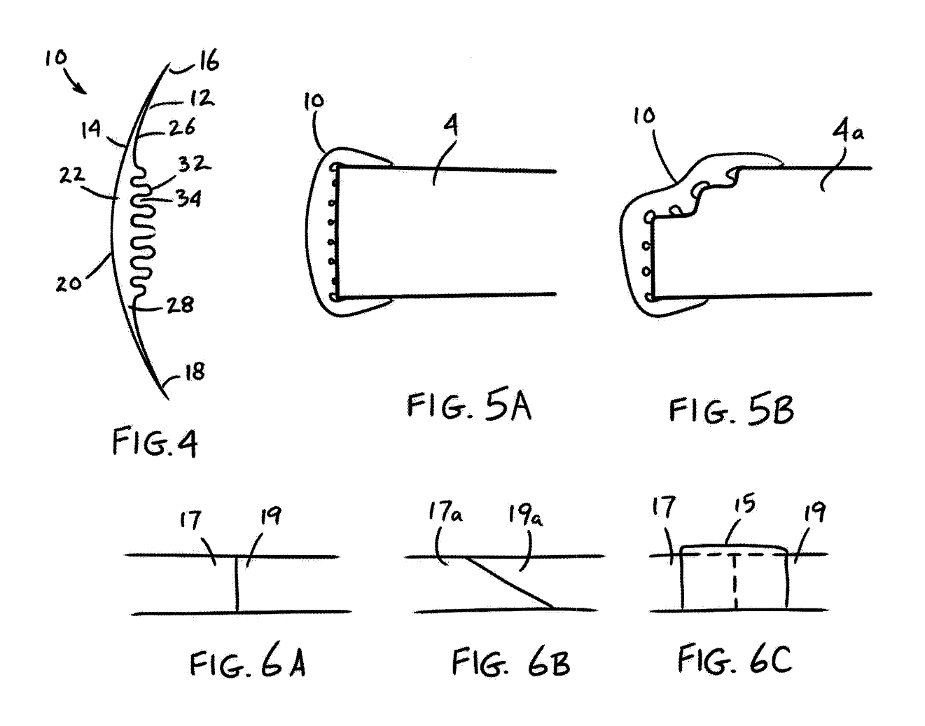

Referring now to the drawings in detail wherein like numbers represent like elements throughout, FIG. 1 illustrates a cushioning device, generally identified 10, that is constructed in accordance with the present invention. The cushioning device 10 is essentially a longitudinally-extending band-like structure in the preferred embodiment, the device 10 having an inner surface 12 and an outer surface 14. As shown in FIGS. 3 and 4, and particularly shown in cross-section, the cushioning device 10 is a symmetrical and outwardly curved body 20. The curved body 20 comprises a central portion 22, an upper edge 16 and a lower edge 18, the edges 16, 18 extending away from the central portion 22. The curved body 20 is outwardly curved beginning at the edges 16, 18 and moving toward the central portion 22. This curvature is preferred in view of objects that the device 10 will be used with, such as with a table 1 having a table top 2 and the table top 2 having an edge 4, as will be further apparent later in this detailed description.

In the preferred embodiment, the central portion 22 of the body 20 has a thickness. Moving away from the central portion 22 and towards each edge 16, 18, it will be seen that the thickness of the device 10 is reduced. This reduction in thickness creates an upper tapered portion 26 and a lower tapered portion 28 in the body 20.

The outer surface 14 of the cushioning device 10 comprises a smooth surface. However, the inner surface 12, at the central portion 22 of the cushioning device 10, comprises a plurality of longitudinally-extending spine-like structures 32. Between each spine-like structure 32 is a longitudinally-extending gap 34. In this configuration, and when the device 10 is wrapped around the edge of a table, for example, the gaps 34 allow the spine-like structures 32 to collapse and allow the profile of the inner surface 12 to conform to the profile of the table edge 4 as shown in FIG. 5A. The cushioning device 10, being configured of an elastomeric material, can also conform to the profile of a table edge 4a that is irregular or contoured. See FIG. 5B.

In the assembly of the present invention, the device 10 can comprise a single band-like structure or it may comprise two ends 17, 19. See FIG. 3. The ends 17, 19 are secured together by a fastening means. The fastening means could comprise a butted end-to-end fusion of the ends 17, 19 as shown in FIG. 6A, an overlapping fusion of the angled ends 17a, 19a as shown in FIG. 6B or secured using a separate piece of material 15 that surrounds both ends and secures them in an end-to-end fashion as shown in FIG. 6C. Each fastening means could comprise a thermal and/or chemical fusion process.

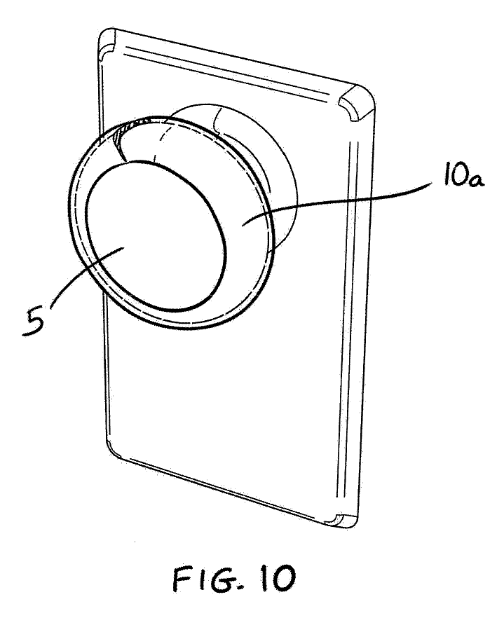

Also in the assembly of the present invention, the cushioning device 10 could be a substantially smaller looped structure 10a that is configured to allow the device 10 to be stretched slightly and then placed about another structure, such as a door knob 5. See FIG. 10.

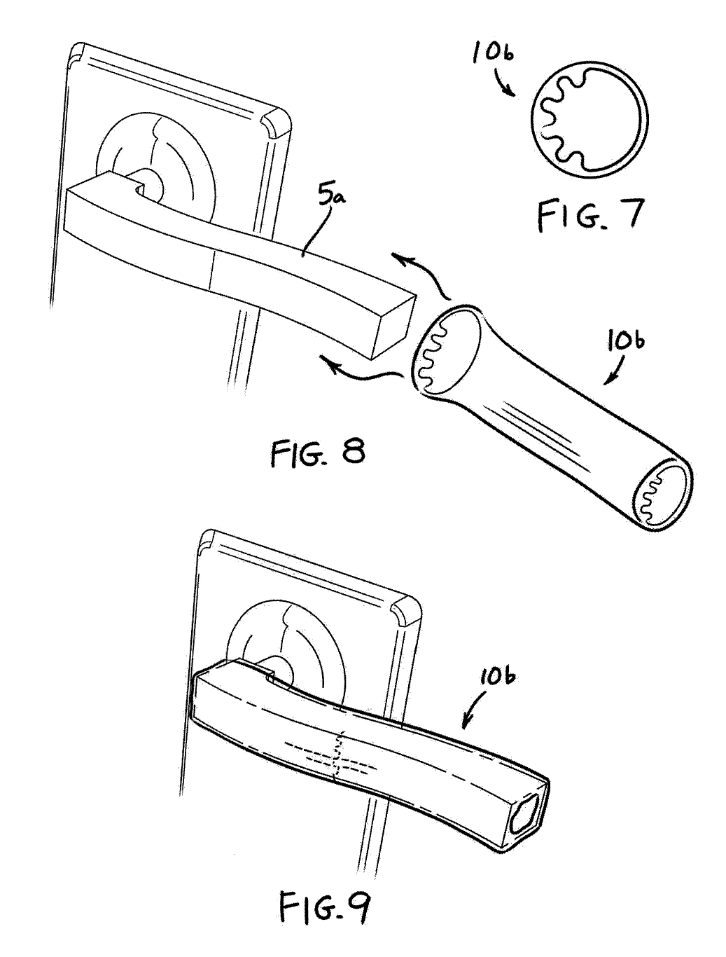

Also in the assembly of the present invention, the device 10 could comprise more of a tube-like structure 10b where the ends 16, 18 of the device 10 are effectively fused together. See FIGS. 7 through 9. In this fashion, the device 10b can be used to envelop sharp-edged or L-shaped door handles 5a, door stops and the like.

Significantly, the material that is preferred for use in fabricating the device 10 is a clear, or nearly transparent, silicone-based material. This provides elasticity to the device 10 which allows it to be used with a wide variety of furniture and other items. This also provides the aesthetically-pleasing result of the device 10 effectively “blending in” with the object to which it is attached or with which it is used and making it effectively “invisible” when used.

In the method of the present invention, a table or other furniture item or object is first identified as having a potentially hazardous edge or corner. The perimeter of the object is measured and then the properly-sized cushioning device 10 is chosen. Preferably, and to ensure a proper fit, the device 10 should be undersized but capable of expansion to accommodate the perimeter of the object and thereby suitably adhere to it with only the use of elastomeric “memory” of the device, which memory wants to return the device 10 to its original size and shape. This results in pressure being applied to the central portion 22 of the device. This pressure, in turn, compacts or compresses the spine-like structures 32 into the adjacent gaps 34 which results in the device 10 assuming the contour or shape of the edge or corner 4, 4a to which it is applied. Again, see FIGS. 5A and 5B. This is particularly important because it allows the device 10 to be effectively used with virtually any contoured edge or corner. Another interesting thermodynamic phenomenon relating to the stretching of elastomeric materials is that, when stretched, the elastomeric device 10 will create heat as a by-product of its expansion. This heat actually aids into the deformation of the spine-like structures 32 during application of the device 10 to the edge 4, 4a of the table 1 or other object, the heat making those structures 32 more pliable and flexible during application.

In an alternative method, the edge 4 of a table top 2 or other object is again identified as having a potentially hazardous edge or corner 4. The perimeter of the object 2 is again determined. An appropriate length of the cushioning device 10 is chosen. Again, the length of the device 10 should be undersized but capable of expansion to accommodate the measured perimeter of the object 2. The device 10 is then cut to the appropriate size and the two ends 17, 19 of the device 10 are fused together, thermally, chemically or mechanically, and the device 10 is stretched and then applied to the object. As described above, this results in pressure being applied to the central portion 22 of the device 10. This pressure, in turn, compacts or compresses the spine-like structures 32 into the adjacent gaps 34 which results in the device 10 more accurately assuming the shape of the edge or corner 4, 4a to which it is applied. This, in turn, provides greater protection because voids 34 between the device 10 and the surface contours are effectively eliminated or, where not eliminated, cause the device 10 to have more shock-absorbing capacity.

In view of the foregoing, it will be appreciated that the present invention provides for a cushioning device, as well as to a system and a method of using such device, that protects children from injuries when they come into unintended contact the corners and edges of tables or other furniture items. The cushioning device and system uses no adhesive, can be easily and removably applied to the table or other furniture item and is aesthetically pleasing to the user because the device is made of a clear, or nearly transparent, elastomeric material. The cushioning device can be configured in a band-like fashion or can be configured in a linear fashion and secured at two ends so as to simulate the band-like structure. The cushioning device further comprises a system whereby the cushioning device uses a connection means to create the band-like structure mentioned above. It also comprises a method for applying the cushioning device to a table or other furniture item in accordance with the present invention.

The principles of this invention having been fully explained in connection with the foregoing, I hereby claim as my invention:

1. A cushioning device for protecting a child or infant from injury by inadvertent contact with an edge or corner of an object, the object comprising a perimeter edge with or without a corner, the cushioning device comprising an longitudinally-extending incurvate band-like body, the body comprising:
a central portion having a thickness;
an upper tapered portion extending upwardly and inwardly of the central portion, the upper tapered portion being reduced in thickness moving away from the central portion and toward an upper edge, the upper tapered portion terminating at the upper edge;
a lower tapered portion extending downwardly and inwardly of the central portion, the lower tapered portion being reduced in thickness moving away from the central portion and toward a lower edge, the lower tapered portion terminating at the lower edge;
an outer surface, the outer surface being substantially smooth;
an inner surface;
a plurality of spine-like structures extending inwardly from the inner surface; and
a plurality of gaps, each gap being positioned between a pair of adjacent spine-like structures.

2. The cushioning device of claim 1 wherein the body comprises an elastomeric material.

3. The cushioning device of claim 2 wherein the elastomeric material is substantially nearly transparent.

4. The cushioning device of claim 3 wherein the body comprises a continuous closed loop.

5. The cushioning device of claim 3 wherein the body comprises a linear body having two ends and the device further comprising means for thermally, chemically or mechanically bonding the ends together to form a continuous closed loop.

6. The cushioning device of claim 4 wherein the closed loop of the body is configured to fit around smaller objects.

7. A cushioning system for protecting a child or infant from injury by inadvertent contact with an edge or corner of an object, the object comprising a perimeter edge with or without a corner, the system comprising:
a longitudinally-extending incurvate band-like body comprising two ends;
means for chemically or mechanically bonding the ends of the body together to form the body into a continuous closed loop;
a central body portion having a thickness;
an upper tapered body portion extending upwardly and inwardly of the central portion, the upper tapered portion being reduced in thickness moving away from the central portion and toward an upper edge, the upper tapered portion terminating at the upper edge;
a lower tapered body portion extending downwardly and inwardly of the central portion, the lower tapered portion being reduced in thickness moving away from the central portion and toward a lower edge, the lower tapered portion terminating at the lower edge;
an outer surface, the outer surface being substantially smooth;
an inner surface;
a plurality of spine-like structures extending inwardly from the inner surface; and
a plurality of gaps, each gap being positioned between a pair of adjacent spine-like structures.

8. The cushioning system of claim 7 wherein the body comprises an elastomeric material.

9. The cushioning system of claim 7 wherein the elastomeric material is substantially nearly transparent.

10. The cushioning system of claim 7 the closed loop of the body is configured to fit around smaller objects.

11. A method for protecting a child or infant from injury by inadvertent contact with an edge or corner of an object, the object comprising a perimeter edge with or without a corner, the method comprising the steps of:
measuring the perimeter edge of the object;
providing a cushioning device having a length that is less than the perimeter edge of the object, the cushioning device comprising a longitudinally-extending incurvate band-like body made of an elastomeric material; the body of the cushioning device comprising a central portion having a thickness; an upper tapered portion extending upwardly and inwardly of the central portion, the upper tapered portion being reduced in thickness moving away from the central portion and toward an upper edge, the upper tapered portion terminating at the upper edge; a lower tapered portion extending downwardly and inwardly of the central portion, the lower tapered portion being reduced in thickness moving away from the central portion and toward a lower edge, the lower tapered portion terminating at the lower edge; an outer surface, the outer surface being substantially smooth; an inner surface; a plurality of spine-like structures extending inwardly from the inner surface; and a plurality of gaps, each gap being positioned between a pair of adjacent spine-like structures; and
applying the cushioning device to the perimeter edge of the object.

12. The method of claim 11 wherein the elastomeric material is substantially nearly transparent.

13. The method of claim 12 wherein the cushioning device providing step comprises the step of providing a body that is formed in a continuous closed loop.

14. The method of claim 12 wherein the cushioning device providing step comprises the steps of providing a body that is formed as a linear body having two ends and thermally, chemically or mechanically bonding the ends together to form a continuous closed loop.

15. The method of claim 14 wherein the closed loop of the body is configured to fit around smaller objects.
